(19) United States
(12) Patent Application Publication
(10) Pub. No.: US 2026/0049892 A1
(43) Pub. Date: Feb. 19, 2026

(54) MULTI-CHANNEL FLOW-MAKING DEVICE AND METHOD FOR LARGE-SCALE EXPERIMENTAL WATER TANK

(71) Applicant: Tianjin University, Tianjin (CN)

(72) Inventors: Xiang Yan, Tianjin (CN); Zhenyu Li, Tianjin (CN); Qinghua Han, Tianjin (CN); Zhigang Bai, Tianjin (CN); Jinyuan Zhang, Tianjin (CN); Mingjie Liu, Tianjin (CN); Hao Wu, Tianjin (CN)

(21) Appl. No.: 19/005,977

(22) Filed: Dec. 30, 2024

(30) Foreign Application Priority Data
Aug. 19, 2024 (CN) 202411140420.X

(51) Int. Cl. G01M 10/00

(52) U.S. Cl. CPC G01M 10/00

(57) ABSTRACT

Disclosed is a multi-channel flow-making device and method for a large-scale experimental water tank. The flow-making device includes a large-scale experimental water tank bottom, flow-making water pumps, flow meters, pressure gauges, a lower annular backflow corridor, outflow corridors for gradual transition section, upper corridors, and a control system. The present disclosure solves the problems of low efficiency, poor uniformity, limited flexibility, unreasonable structural and spatial design, and high cost existing in the existing flow-making methods.

### CROSS-REFERENCE TO RELATED APPLICATION

This application claims priority of Chinese Patent Application No. 202411140420.X, filed on Aug. 19, 2024, the entire contents of which are incorporated herein by reference.

### TECHNICAL FIELD

The present disclosure relates to a flow-making device, and specifically relates to a multi-channel flow-making device and method for a large-scale experimental water tank.

### BACKGROUND

In fields such as civil engineering, water conservancy project, and ocean engineering, large-scale experimental water tanks are widely applied to simulate natural water environments for conducting various hydraulic experiments. The conventional flow-making methods typically involve using a single channel or limited water pump configurations in the water tank to generate the desired water flow environment. However, these existing flow-making methods have some limitations when applied in large-scale experimental water tanks, mainly including the following problems.

(1) Efficiency and uniformity problems: it is often difficult for the existing flow-making methods to create a uniform and efficient water flow environment in the entire water tank, especially in water tanks of different shapes and sizes. This may lead to inaccurate experimental results.

(2) Lack of flexibility: since the existing technologies generally lack flexibility in water flow direction and intensity, it is unable to make timely adjustment according to specific experimental needs.

(3) Spatial and structural constraints: in some designs, the configuration of water pump and pipeline occupies space of the water tank, limiting the mounting and operation of other equipment (such as underwater vibration tables) and increasing investment in civil engineering.

(4) Cost and maintenance problems: relying on complex pipeline and metal structures, the existing system is higher in cost during initial construction, and involves more costs during maintenance and replacement, as well as higher energy consumption during operation.

Based on this, the present disclosure proposes a multi-channel flow-making device and method for a large-scale experimental water tank to solve the above technical problems.

### SUMMARY

The present disclosure provides a multi-channel flow-making device and method for a large-scale experimental water tank. By arranging a plurality of flow-making water pumps on two sides of the water tank, an efficient water flow circulation system is formed. With the design of the lower annular backflow corridor and the upper corridor, a uniform water flow distribution is achieved across the entire water tank, optimizing the operation efficiency of the water pumps and the control system, enhancing the reliability and continuity of the entire system, and solving the problems of low efficiency, poor uniformity, limited flexibility, unreasonable structural and spatial design, and high cost existing in the existing flow-making methods.

In a first aspect, the present disclosure provides a multi-channel flow-making device for a large-scale experimental water tank, with the following technical solutions employed.

The current generating device includes a large-scale experimental water tank bottom, flow-making water pumps, flow meters, pressure gauges, a lower annular backflow corridor, outflow corridors for gradual transition section, upper corridors, and a control system.

The outflow corridors for gradual transition section, a plurality of flow-making water pumps, and the upper corridors are sequentially arranged on two sides of the large-scale experimental water tank bottom; two ends of the flow-making water pump are communicated with the outflow corridor for gradual transition section and the upper corridor, respectively; the lower annular backflow corridor is horizontally arranged around a periphery of the large-scale experimental water tank bottom in an annular direction; the upper corridors are located above the lower annular backflow corridor and arranged along a wall of the large-scale experimental water tank; the upper corridors are communicated with the lower annular backflow corridor; and the lower annular backflow corridor is filled with water.

The flow-making water pumps on one side of the large-scale experimental water tank bottom serve as outflow water pumps for water pumping, and the flow-making water pumps on the other side serve as backflow water pumps for water discharging.

Each flow-making water pump is equipped with the flow meter and the pressure gauge; the flow meter serves for collecting flow rate data from the flow-making water pump; and the pressure gauge serves for collecting pressure data from the flow-making water pump.

The control system is electrically connected to the flow meters and the pressure gauges; and the control system is capable of monitoring and adjusting the operating status of the flow-making water pumps in real-time, regulating operating parameters of the flow-making water pumps according to the data collected by the flow meters and the pressure gauges, and adjusting the operating status of the flow-making water pumps according to testing requirements.

Preferably, the flow-making water pumps are large-scale and open-type crossflow water pumps with low lift and high flow rate.

Preferably, 24 outflow water pumps and 24 backflow water pumps are equipped.

Preferably, the lower annular backflow corridor, the outflow corridors for gradual transition section, and the upper corridors are all constructed using concrete materials.

Preferably, an opening of a cross section of the outflow corridor for gradual transition section gradually increases from one end connected to the flow-making water pump to the other end.

Preferably, an opening of a cross section of the upper corridor gradually increases from one end connected to the flow-making water pump to the other end.

In a second aspect, the present disclosure provides a multi-channel flow-making method for a large-scale experimental water tank, using the above flow-making device for flow making. When flow making is initiated, the outflow water pumps on one side of the large-scale experimental water tank bottom pump water from the lower annular backflow corridor to the upper corridors. The water, after passing through pump bodies, flows into the large-scale experimental water tank bottom through the outflow corridors for gradual transition section, forming water flow circulation across the entire water tank. The water, after flowing across the entire water tank, passes through the outflow corridors for gradual transition section on the other side, and is discharged into the upper corridor by the backflow water pumps. Subsequently, the water flows back to the lower annular backflow corridor to complete a full water flow circulation process.

In a case that the water flows through the outflow water pumps and the backflow water pumps, the flow meters and the pressure gauges collect real-time data about flow rate and pressure inside the pump bodies, and the control system monitors the operating status of the outflow water pumps and the backflow water pumps in real-time and makes timely adjustments.

The present disclosure has the following advantageous effects.

(1) The present disclosure provides an efficient flow-making method, which combines water pumping and discharging at two ends of the experimental water tank, cooperating with large-scale water conveyance corridors for backflow, to form an efficient water flow circulation system. This flow-making design allows for rapidly establishing a stable water flow environment and ensures uniform water flow distribution across the entire water tank. Through the coordinated operation of flow-making water pumps on two sides, continuous water flow circulation is achieved, enabling the experimental water tank to maintain a long-term and stable flow-making state. Additionally, this method reduces energy loss in the water flow path, improves the overall efficiency and operational stability of the system, and is suitable for various complex experimental conditions.

(2) The multi-pump coordinated control system of the present disclosure not only guarantees the flexibility and diversity of the flow-making process but also achieves precise control of water pump performance through real-time data feedback from flow meters and pressure gauges. This highly precise control mechanism enables the present disclosure to meet variable experimental conditions. Whether it requires uniform flow, locally enhanced flow, or flow in a specific direction, the control system can quickly respond by adjusting the corresponding water pump parameters, which not only enhances the flexibility and accuracy of experiments but also improves the adaptability of the entire system, allowing it to maintain efficiency and accuracy in a series of complex experimental designs. Furthermore, this coordinated control reduces the risk of experiment interruption due to equipment failure, improving the reliability and stability of the entire system.

(3) The lower annular backflow corridor of the present disclosure is horizontally arranged on the outer side of the water tank in an annular direction, freeing up the lower space of the water tank and allowing sufficient space to mount underwater vibration tables or other large-scale equipment. This design facilitates the mounting and operation of equipment, adapts to various experimental needs, and improves the flexibility of application of the flow-making device. Meanwhile, the compact design of the upper corridor and the lower annular backflow corridor reduces the occupation of internal space in the water tank, optimizes the overall structural layout, enhances space utilization, and significantly reduces investment in civil engineering.

(4) The water conveyance corridors of the present disclosure are constructed using concrete materials, featuring durability and ease of maintenance. The use of concrete corridors avoids using additional metal or plastic piping systems, thus significantly reducing material costs and later maintenance costs. The reasonable corridor structural design not only ensures efficient backflow of water but also reduces the construction materials and time required during the construction, substantially lowering the overall project cost.

(5) In the present disclosure, crossflow water pumps with low lift and high flow are employed. By optimizing the model selection and configuration of water pumps, it ensures that energy consumption is minimized while meeting flow-making demands. The real-time monitoring and adjustment control system ensures that the water pumps always operate within the optimal efficiency range, thereby reducing energy consumption and significantly lowering operational costs. This high-efficiency operation mode is not only environmentally friendly but also enhances the economic and sustainability of the system.

(6) The multi-channel coordinated control system of the present disclosure guarantees high reliability of system. Even if some water pumps go wrong, flow-making experiments can still be continued. Each set of flow-making water pumps can operate independently and serve as backups for each other. The control system automatically detects water pump status and quickly switches to the standby water pump when a failure occurs. This design not only improves the overall reliability of the system but also ensures the continuity and stability of flow-making experiments, avoiding the adverse effects of experiment interruption and enhancing the stability and safety of the overall system.

### BRIEF DESCRIPTION OF THE DRAWINGS

For the ease of illustration, the present disclosure is described with reference to the specific examples and accompanying drawings in detail below.

FIG. 1 is a perspective view of a flow-making device in an example;

FIG. 2 is another perspective view of the flow-making device in the example;

FIG. 3 is a top view of the flow-making device in the example;

FIG. 4 is a cross sectional view of the flow-making device in the example;

FIG. 5 is a partial view and a partial enlarged view of the flow-making device in the example; and

FIG. 6 is a schematic diagram showing full-field flow making in the example (arrows in the figure indicate the flow direction).

Reference numerals and denotations thereof:
1—large-scale experimental water tank bottom; 2—flow-making water pump; 3—flow meter; 4—pressure gauge; 5—lower annular backflow corridor; 6—outflow corridor for gradual transition section; and 7—upper corridor.

### DETAILED DESCRIPTION

Technical solutions in the examples of the present disclosure will be clearly and completely described below by reference to the accompanying drawings in the examples of the present disclosure. It is to be noted that the following examples and features therein may be combined with each other without conflict, and the examples described are only some rather than all examples of the present disclosure.

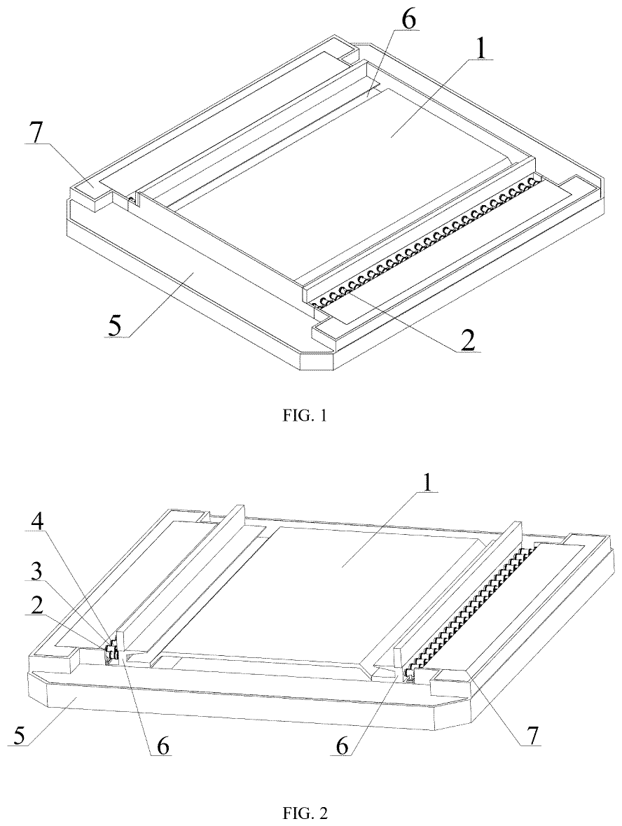

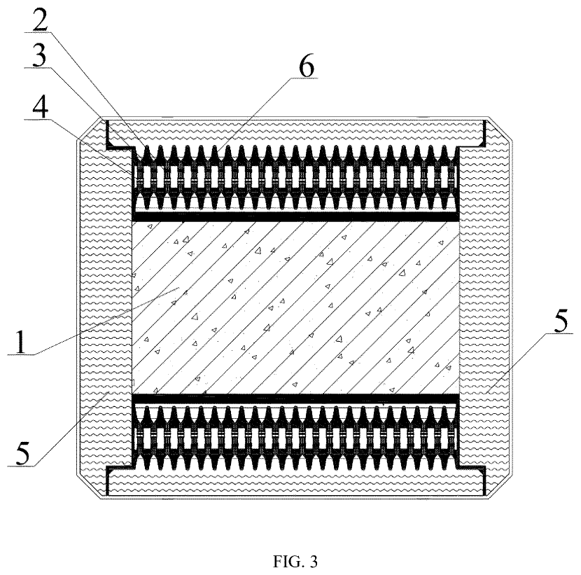

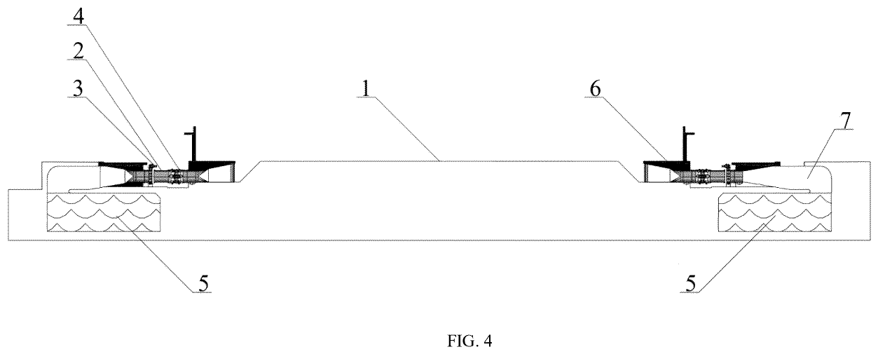

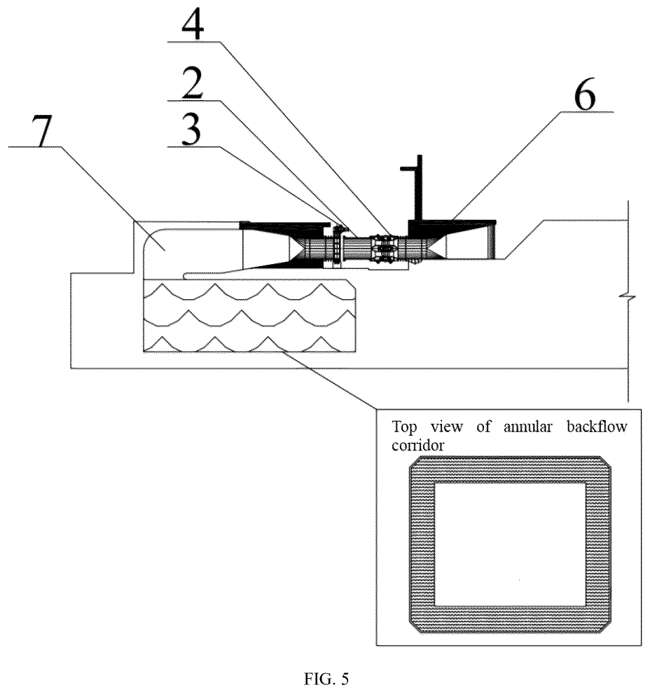

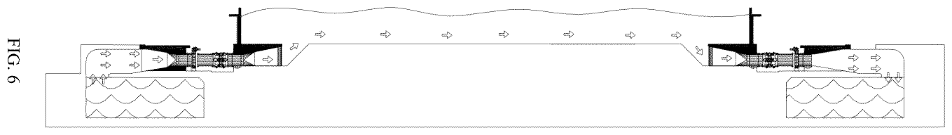

As shown in FIGS. 1-6, a multi-channel flow-making device for a large-scale experimental water tank includes a large-scale experimental water tank bottom 1, flow-making water pumps 2, flow meters 3, pressure gauges 4, a lower annular backflow corridor 5, outflow corridors for gradual transition section 6, upper corridors 7, and a control system. The outflow corridors for gradual transition section 6, a plurality of flow-making water pumps 2, and the upper corridors 7 are sequentially arranged on two sides of the large-scale experimental water tank bottom 1. Two ends of the flow-making water pump 2 are communicated with the outflow corridor for gradual transition section 6 and the upper corridor 7, respectively. The lower annular backflow corridor 5 is horizontally arranged around a periphery of the large-scale experimental water tank bottom 1 in an annular direction. The upper corridors 7 are located above the lower annular backflow corridor 5 and arranged along a wall of the large-scale experimental water tank. The upper corridors 7 are communicated with the lower annular backflow corridor 5. The lower annular backflow corridor 5 is filled with water. The flow-making water pumps 2 on a front side of the large-scale experimental water tank bottom 1 serve as outflow water pumps for water pumping, and the flow-making water pumps 2 on a rear side serve as backflow water pumps for water discharging. Each flow-making water pump 2 is equipped with the flow meter 3 and the pressure gauge 4. The flow meter 3 serves for collecting flow rate data from the flow-making water pump 2. The pressure gauge 4 serves for collecting pressure data from the flow-making water pump 2. The control system is electrically connected to the flow meters 3 and the pressure gauges 4. The control system is capable of monitoring and adjusting the operating status of the flow-making water pumps 2 in real-time, regulating operating parameters of the flow-making water pumps 2 according to the data collected by the flow meters 3 and the pressure gauges 4, and adjusting the operating status of the flow-making water pumps 2 according to testing requirements.

In this example, a flow-making method is shown as FIG. 6. When flow making is initiated, the outflow water pumps on the front side pump water from the lower annular backflow corridor 5 to the upper corridor 7. The water, after passing through pump bodies, flows into the large-scale experimental water tank bottom 1 through the outflow corridors for gradual transition section 6, forming water flow circulation across the entire water tank. The water, after flowing through the entire water tank, passes through the outflow corridors for gradual transition section 6 on the rear side, and is discharged into the upper corridors 7 by the backflow water pumps on the rear side. Subsequently, the water flows back to the lower annular backflow corridor 5 to complete a full water flow circulation cycle.

In this example, the lower annular backflow corridor 5 is horizontally arranged on an outer side of the water tank in an annular direction, freeing up lower space of the water tank. This design provides a flexible layout solution, allowing sufficient space to be reserved at the bottom of the water tank for the mounting of underwater vibration tables or other large-scale equipment. Furthermore, the layout and structural design of the corridor take into account the convenience of equipment mounting and operation, providing a solid infrastructure support for various experimental needs. The upper corridor 7 and the lower annular backflow corridor 5 are in a compact design, occupying little space. The upper corridors 7 are located above the water tank and arranged along a wall of the water tank. The lower annular backflow corridor 5 surrounds a periphery of the water tank. This design not only saves the internal space of the water tank, but also reduces the investment in civil engineering, optimizing the structural layout of the overall water tank, and enhancing space utilization.

In this example, each flow-making water pump is equipped with the flow meter 3 and the pressure gauge 4, providing precise flow rate and pressure data. At the beginning of flow making, according to real-time data collected by the flow meter 3 and the pressure gauge 4, the control system independently adjusts the operating parameters of each water pump, including flow rate and lift, achieving uniform flow throughout the entire water tank or generating localized or diagonally localized flow according to specific experimental requirements. Therefore, the control system ensures that the operating state of each water pump can be flexibly and accurately adjusted in different experimental scenarios, to achieve the optimal flow-making effect. In addition, the multi-pump coordinated control system can ensure that the flow-making experiment still be continued even if some of the flow-making water pumps 2 go wrong. The flow-making water pumps 2 on each side can operate independently and serve as backups for each other. The control system automatically detects the water pump status and swiftly switches to the standby water pump in case of a failure. This design not only enhances the overall reliability of the system but also guarantees the continuity and stability of the flow-making experiment.

Further, in this example, the flow-making water pumps include 24 outflow water pumps and 24 backflow water pumps, which are large-scale and open-type crossflow water_pumps with low lift and high flow, optimizing the operating efficiency of water pump. The model selection and configuration of the water pump, after meticulous calculations, ensure that energy consumption is minimized as much as possible while meeting the flow-making requirements. The real-time monitoring and adjustment of the water pumps by the control system keeps the water pumps operating within the optimal efficiency range, thereby reducing energy consumption and lowering operational costs.

Further, in this example, the lower annular backflow corridor 5, the outflow corridors for gradual transition section 6, and the upper corridors 7 are all constructed using concrete materials, ensuring their robustness, durability, and ease of maintenance. The direct use of concrete corridors for water backflow avoids using additional metal or plastic pipeline systems, significantly reducing material costs and later maintenance costs. Additionally, the optimized corridor design minimizes the construction materials and time required during the construction.

Further, an opening of a cross section of the outflow corridor for gradual transition section 6 gradually increases from one end connected to the flow-making water pump 2 to the other end, and an opening of a cross section of the upper corridor 7 gradually increases from one end connected to the flow-making water pump 2 to the other end. This design facilitates the pumping or discharging by the flow-making water pump 2 and improves efficiency.

In summary, according to the multi-channel flow-making device and method of the present disclosure, an efficient water flow circulation system is formed by arranging 24 large-scale and open-type crossflow water pumps with low head and high flow on two sides of the large-scale experimental water tank bottom 1. With the design of the lower annular backflow corridor 5 and the upper corridor 7, the uniform water flow distribution throughout the entire water tank is achieved, optimizing operating efficiency of water pump and the control system, enhancing the reliability and continuity of the entire system, thereby achieving efficient, flexible, low-cost, and reliable flow making.

In the description of the present application, it is to be understood that, the orientation or state relations indicated by the terms “front”, “rear”, etc. are based on those shown in the accompanying drawings and merely for the ease of describing the present application and simplifying the description, rather than indicating or implying that the device or element referred to must be in a specific orientation or constructed and operated in a specific orientation, and therefore cannot be interpreted as limiting the present application.

The above disclosed examples of the present application serve merely for helping explain the present disclosure. Although the preferred examples are not described in detail, the present application is not limited to the specific embodiment described above. Many modifications and changes can be made according to the contents of the examples of this specification. These examples selected and specifically described in the specification are to better explain the principle and practical application of the present application, so that those skilled in the art can well understand and utilize the present application.

1. A multi-channel flow-making device for a large-scale experimental water tank, comprising:
a large-scale experimental water tank bottom (1), flow-making water pumps (2), flow meters (3), pressure gauges (4), a lower annular backflow corridor (5), outflow corridors for gradual transition section (6), upper corridors (7), and a control system, wherein the outflow corridors for gradual transition section (6), a plurality of flow-making water pumps (2), and the upper corridors (7) are sequentially arranged on two sides of the large-scale experimental water tank bottom (1); two ends of the flow-making water pump (2) are communicated with the outflow corridor for gradual transition section (6) and the upper corridor (7), respectively; the lower annular backflow corridor (5) is horizontally arranged around a periphery of the large-scale experimental water tank bottom (1) in an annular direction; the upper corridors (7) are located above the lower annular backflow corridor (5) and arranged along a wall of the large-scale experimental water tank; the upper corridors (7) are communicated with the lower annular backflow corridor (5); and the lower annular backflow corridor (5) is filled with water;
the flow-making water pumps (2) on one side of the large-scale experimental water tank bottom (1) serve as outflow water pumps for water pumping, and the flow-making water pumps (2) on the other side serve as backflow water pumps for water discharging;
each flow-making water pump (2) is equipped with the flow meter (3) and the pressure gauge (4); the flow meter (3) serves for collecting flow rate data from the flow-making water pump (2); and the pressure gauge (4) serves for collecting pressure data from the flow-making water pump (2); and
the control system is electrically connected to the flow meters (3) and the pressure gauges (4); and the control system is capable of monitoring and adjusting the operating status of the flow-making water pumps (2) in real-time, regulating operating parameters of the flow-making water pumps (2) according to the data collected by the flow meters (3) and the pressure gauges (4), and adjusting the operating status of the flow-making water pumps (2) according to testing requirements.

2. The multi-channel flow-making device for a large-scale experimental water tank according to claim 1, wherein the flow-making water pumps (2) are large-scale and open-type crossflow water pumps with low lift and high flow rate.

3. The multi-channel flow-making device for a large-scale experimental water tank according to claim 1, wherein 24 outflow water pumps and 24 backflow water pumps are equipped.

4. The multi-channel flow-making device for a large-scale experimental water tank according to claim 1, wherein the lower annular backflow corridor (5), the outflow corridors for gradual transition section (6), and the upper corridors (7) are all constructed using concrete materials.

5. The multi-channel flow-making device for a large-scale experimental water tank according to claim 1, wherein an opening of a cross section of the outflow corridor for gradual transition section (6) gradually increases from one end connected to the flow-making water pump (2) to the other end.

6. The multi-channel flow-making device for a large-scale experimental water tank according to claim 1, wherein an opening of a cross section of the upper corridor (7) gradually increases from one end connected to the flow-making water pump (2) to the other end.

7. A multi-channel flow-making method for a large-scale experimental water tank, enabling the flow-making device according to claim 1 to make flow, comprising the following steps:
when initiating flow making, pumping water from the lower annular backflow corridor (5) to the upper corridors (7) by the outflow water pumps on one side of the large-scale experimental water tank bottom (1), and allowing the water, after passing through pump bodies, to flow into the large-scale experimental water tank bottom (1) through the outflow corridors for gradual transition section (6), forming water flow circulation across the entire water tank; and allowing the water, after flowing across the entire water tank, to pass through the outflow corridors for gradual transition section (6) on the other side, and discharging the water into the upper corridors (7) by the backflow water pumps, and the water subsequently flowing back to the lower annular backflow corridor (5) to complete a full water flow circulation process.

8. A multi-channel flow-making method for a large-scale experimental water tank, enabling the flow-making device according to claim 2 to make flow, comprising the following steps:
when initiating flow making, pumping water from the lower annular backflow corridor (5) to the upper corridors (7) by the outflow water pumps on one side of the large-scale experimental water tank bottom (1), and allowing the water, after passing through pump bodies, to flow into the large-scale experimental water tank bottom (1) through the outflow corridors for gradual transition section (6), forming water flow circulation across the entire water tank; and allowing the water, after flowing across the entire water tank, to pass through the outflow corridors for gradual transition section (6) on the other side, and discharging the water into the upper corridors (7) by the backflow water pumps, and the water subsequently flowing back to the lower annular backflow corridor (5) to complete a full water flow circulation process.

9. A multi-channel flow-making method for a large-scale experimental water tank, enabling the flow-making device according to claim 3 to make flow, comprising the following steps:
when initiating flow making, pumping water from the lower annular backflow corridor (5) to the upper corridors (7) by the outflow water pumps on one side of the large-scale experimental water tank bottom (1), and allowing the water, after passing through pump bodies, to flow into the large-scale experimental water tank bottom (1) through the outflow corridors for gradual transition section (6), forming water flow circulation across the entire water tank; and allowing the water, after flowing across the entire water tank, to pass through the outflow corridors for gradual transition section (6) on the other side, and discharging the water into the upper corridors (7) by the backflow water pumps, and the water subsequently flowing back to the lower annular backflow corridor (5) to complete a full water flow circulation process.

10. A multi-channel flow-making method for a large-scale experimental water tank, enabling the flow-making device according to claim 4 to make flow, comprising the following steps:
when initiating flow making, pumping water from the lower annular backflow corridor (5) to the upper corridors (7) by the outflow water pumps on one side of the large-scale experimental water tank bottom (1), and allowing the water, after passing through pump bodies, to flow into the large-scale experimental water tank bottom (1) through the outflow corridors for gradual transition section (6), forming water flow circulation across the entire water tank; and allowing the water, after flowing across the entire water tank, to pass through the outflow corridors for gradual transition section (6) on the other side, and discharging the water into the upper corridors (7) by the backflow water pumps, and the water subsequently flowing back to the lower annular backflow corridor (5) to complete a full water flow circulation process.

11. A multi-channel flow-making method for a large-scale experimental water tank, enabling the flow-making device according to claim 5 to make flow, comprising the following steps:
when initiating flow making, pumping water from the lower annular backflow corridor (5) to the upper corridors (7) by the outflow water pumps on one side of the large-scale experimental water tank bottom (1), and allowing the water, after passing through pump bodies, to flow into the large-scale experimental water tank bottom (1) through the outflow corridors for gradual transition section (6), forming water flow circulation across the entire water tank; and allowing the water, after flowing across the entire water tank, to pass through the outflow corridors for gradual transition section (6) on the other side, and discharging the water into the upper corridors (7) by the backflow water pumps, and the water subsequently flowing back to the lower annular backflow corridor (5) to complete a full water flow circulation process.

12. A multi-channel flow-making method for a large-scale experimental water tank, enabling the flow-making device according to claim 6 to make flow, comprising the following steps:
when initiating flow making, pumping water from the lower annular backflow corridor (5) to the upper corridors (7) by the outflow water pumps on one side of the large-scale experimental water tank bottom (1), and allowing the water, after passing through pump bodies, to flow into the large-scale experimental water tank bottom (1) through the outflow corridors for gradual transition section (6), forming water flow circulation across the entire water tank; and allowing the water, after flowing across the entire water tank, to pass through the outflow corridors for gradual transition section (6) on the other side, and discharging the water into the upper corridors (7) by the backflow water pumps, and the water subsequently flowing back to the lower annular backflow corridor (5) to complete a full water flow circulation process.

13. The multi-channel flow-making method for a large-scale experimental water tank according to claim 7, wherein in a case that the water flows through the outflow water pumps and the backflow water pumps, the flow meters (3) and the pressure gauges (4) collect real-time data about flow rate and pressure inside the pump bodies, and the control system monitors the operating status of the outflow water pumps and the backflow water pumps in real-time and makes timely adjustments.
